(19) United States
(12) Patent Application Publication
(10) Pub. No.: US 2024/0416490 A1
(43) Pub. Date: Dec. 19, 2024

(54) ELECTRICALLY ISOLATED OR INSULATED ROTARY TOOL

(71) Applicant: Wiha Werkzeuge GmbH, Schonach (DE)

(72) Inventors: Holger KNAUST, Neuenburg (DE); Thomas SCHANDELMEIER, St. Georgen (DE)

(73) Assignee: Wiha Werkzeuge GmbH, Schonach (DE)

(21) Appl. No.: 18/210,294

(22) Filed: Jun. 15, 2023

(51) Int. Cl. B25B 21/00; B25B 23/00

(52) U.S. Cl. CPC B25B 21/004; B25B 23/0035

(57) ABSTRACT

In a rotary tool (1) for tightening or releasing a screw connection, in which the rotary tool (1) has a freewheel mechanism (29), it is provided that the rotary tool (1) is configured to be electrically isolated in a partial region between a tool attachment point (6) and the freewheel mechanism (29).

### TECHNICAL FIELD

The invention relates to a rotary tool for tightening or releasing a screw connection, wherein the rotary tool has a freewheel mechanism. Such a rotary tool has many different applications in practice.

### BACKGROUND

Rotary tools are also called ratchet wrenches, ratchets or screwing tools in practice and have the advantage relative to a conventional wrench that they do not have to be repeatedly re-positioned when there is too little room available in order to be able to perform a complete revolution when the wrench is in position. In order to tighten or release a screw connection in a stepwise manner, the rotary tool is instead repeatedly moved to and fro by a specific angle. The rotary tool transmits the manual force directly onto the nut or bolt in the one rotational direction. In the opposing rotational direction, however, no force is transmitted and the rotary tool rotates freely, wherein at the same time a mechanical clicking noise is generated. So that the rotary tool is suitable both for releasing and tightening, this function can be switched over by a small lever or rotating ring on the rotary tool head so that the respective rotational directions for a freewheel which generates a clicking noise and for a silent force transmission are swapped with one another.

In practice, freewheel mechanisms can have different force transmission elements, for example clamping rollers, clamping bodies, locking pawls, claw rings or wrap springs.

Rotary tools or ratchet wrenches are very important in automotive engineering and also in mechanical engineering and tool making and assembly technology.

A wrench for screwing a workpiece which has a screwing portion and a gripping portion is disclosed in EP 3 292 956 B1.

A ratchet which has a ring portion and a hand portion is disclosed in EP 1 380 390 A2. A holder holds the force transmission elements which are configured as cylindrical rollers. The cylindrical rollers run on groove-shaped recesses which are stamped onto an inner lateral surface of the ring portion.

A reversible wrench which comprises a handle, a carrier on the handle, a torque transmission unit, an internal driven element, a movement transfer unit and a selector is disclosed in WO 2016/145491 A1.

Rotary tools with a ratchet mechanism or a ratchet freewheel are primarily used in the prior art.

### SUMMARY

The clamping roller mechanism of the present invention provides an advantageous alternative here to the hitherto standard ratchet freewheels.

It is known that such rotary tools have to have a higher proportion of metal since the latching mechanism or the clamping roller mechanism is formed from metal.

The object of the invention is to broaden the field of use of such rotary tools, to improve the usage properties and to enhance the safety for a user. The object is achieved by a rotary tool having one or more of the features disclosed herein. Advantageous embodiments are described below and in the claims.

It should be mentioned that the features set forth individually in the dependent claims can be combined together in any technologically expedient manner and define further embodiments of the invention. Moreover, the features specified in the claims are clarified and explained in the description, wherein further preferred embodiments of the invention are set forth.

To achieve this object, the invention proposes a rotary tool of the type described in the introduction, for solving the aforementioned object that is configured to be electrically isolated at least in a partial region between a tool attachment point and the freewheel mechanism. Thus a user of the rotary tool can be protected from electrical sparking or an electric shock when the rotary tool acts on an electrically conductive tool attachment point.

Advantageous embodiments of the invention which can be combined individually or in combination with the features of other embodiments, are described hereinafter.

In an advantageous embodiment, it can be provided that the freewheel mechanism is configured as a clamping roller mechanism. Thus it is possible to use a freewheel mechanism which is mechanically stable and reliable and easily producible.

Other freewheel mechanisms, such as for example locking pawl mechanisms or claw ring mechanisms, are associated in practice with a greater level of production effort.

In an advantageous embodiment, it can be provided that the rotary tool has a changeover device for the freewheel mechanism. Thus the direction of rotation of the freewheel mechanism can be set or a switching position can be switched, wherein the freewheel mechanism is able to transmit torque in one rotational direction and is not able to transmit torque in the other rotational direction.

In an advantageous embodiment, it can be provided that the changeover device cooperates with an adapter element for fixing at least one switching position, wherein the adapter element is connected fixedly in terms of rotation to a drive shaft of the rotary tool. Thus the switching position can be set and predetermined by the adapter element.

In an advantageous embodiment, it can be provided that the adapter element and the drive shaft are produced from different materials. Thus an optimized material pairing can be provided, which can reduce the wear caused by the use of the rotary tool.

In total there are two possible switching positions: a switching position in which the drive shaft can be rotated clockwise and a different switching position in which the drive shaft can be rotated counterclockwise.

The rotary tool has a crown-like and rotatable ring which encloses a push button and whereby the changeover device can be actuated and the switching position can be set. The user can thus set the possible rotational direction of the drive shaft of the rotary tool by rotating the ring. The ring is operatively connected to the adapter element.

In an advantageous embodiment, it can be provided that the freewheel mechanism has clamping elements. Preferably, the clamping elements are rolling bodies. Particularly preferably, the rolling bodies are balls or cylindrical rollers. Thus it is possible to use rolling bodies which can be produced in a simple and inexpensive manner.

In an advantageous embodiment, it can be provided that at least three clamping elements are configured. Thus it is possible to reduce the production effort and the weight of the rotary tool, which advantageously has an effect on the ease of use and producibility of the rotary tool.

In an advantageous embodiment, it can be provided that the changeover device has spring elements which assist the positioning of the changeover device in the end positions. For the user, this has a positive effect on the user-friendliness and the safety in use.

In an advantageous embodiment, it can be provided that the adapter element has end stops on both sides for the changeover device. Thus the adapter element can be positioned efficiently and reliably in the changeover device and set the possible rotational direction. Preferably, the end stops are configured on the spring elements.

In an advantageous embodiment, it can be provided that the spring elements provide a radial spring assembly. “Radial” can mean in this context that the spring assembly acts at right angles to the main axis of the drive shaft. Thus the adapter element can be guided carefully on the spring elements, wherein, due to the radial spring assembly, the spring elements and the adapter element are not able to be subjected to as much wear over time.

In an advantageous embodiment, it can be provided that the spring elements are produced from plastics. Preferably, this plastic is polyoxymethylene (POM). The invention has identified here for the first time that this specific plastic has a long service life and positive user properties. Additionally, the general weight of the rotary tool can be reduced by the use of the material.

In an advantageous embodiment, it can be provided that the adapter element is produced from plastics. Preferably, this plastic is a polyamide. Thus the weight can be reduced and the user properties improved.

It is also conceivable that the adapter element is produced from POM and the spring elements are produced from polyamide. It is important for the invention that this combination of materials is particularly advantageous relative to the service life and wear.

It can be advantageous that the changeover device can be configured by an action of plastics on plastics, so that it is possible to avoid a pairing of plastics with metal, which hitherto was standard in the prior art. This can reduce the wear of the parts made of plastics and thus increase the service life of the changeover device.

The contact of plastics with plastics can have the advantage that the sliding friction can be improved, such that a resistance against a switching movement can be achieved by a shaping of the spring elements.

The changeover device advantageously has three spring elements which can be arranged at an angle of 120° to one another. The changeover device can also alternatively have only one spring element.

In an advantageous embodiment, it can be provided that the spring elements are arranged in the form of a latching sliding guide. Thus it is possible to provide a mechanically advantageous and stable shape.

In an advantageous embodiment, it can be provided that a securing element is configured, said securing element encompassing the drive shaft and additionally or alternatively axially securing the adapter element. “Axially” can refer to the direction of the main axis of the drive shaft of the rotary tool. Preferably, the securing element is configured to be disk-shaped. Preferably, the securing element is a securing ring. The securing element can be produced from a metal, which is advantageous for the strength of the securing element. Additionally, the securing element can have an opening so that the securing element can be placed in its position, wherein the securing element encompasses the drive shaft. Thus it is possible to provide a simple and reliable mechanical arrangement.

In an advantageous embodiment, it can be provided that a non-conductive labyrinth structure is formed between the securing element and a handle. Preferably, the labyrinth structure is produced from plastics. It is advantageous that the creepage distances and air gaps are extended due to the labyrinth structure which bears against the securing element, so that legal regulations and standards can be met relative to product safety in the case of electrical sparking.

In an advantageous embodiment, it can be provided that the freewheel mechanism is supported via an axial rolling bearing on the drive shaft. Preferably, a part of the freewheel mechanism, which is connected fixedly in terms of rotation to the handle, is supported via an axial roller bearing on the drive shaft. Thus an axial application of force by a user can be diverted with reduced friction. An axial action of force on the clamping elements, for example the clamping rollers, does not take place here. This leads to greater ease of use during the movement counter to the rotational direction.

In an advantageous embodiment, it can be provided that the freewheel mechanism has a latching mechanism. Thus an acoustic/haptic feedback can be generated during a movement of the freewheel mechanism. This is advantageous for the ease of use of the rotary tool and for the ease of operation for the user as a whole.

In an advantageous embodiment, it can be provided that the latching mechanism has two latching elements which run on a latching profile of predetermined spacing, wherein the latching elements are arranged offset to one another by a fraction of the spacing. Preferably, the latching elements are configured as latching balls. Preferably, the fraction of the spacing is an angle of less than 10°. Thus a desired frequency of the acoustic feedback can be set relative to a rotational angle by a selected positioning of the latching elements to one another.

The latching mechanism can have at least two latching balls and a latching profile, wherein an angular offset of the two latching balls to one another is not an integer multiple of a spacing of the latching profile. This generates the impression of a particularly high quality tool for the user.

In an advantageous embodiment, it can be provided that the handle, which preferably consists of plastics, has a hollow interior which is fully sealed relative to the freewheel mechanism by means of an insulator. The insulator can be formed by a one-piece plastics shaped portion and additionally or alternatively can be located between the interior and the freewheel mechanism. Thus it is possible to prevent an electric shock for a user.

In an advantageous embodiment, it can be provided that sockets, and additionally or alternatively bits, can be introduced in the interior and that additionally or alternatively the interior can be closed by a closure cap. Thus it is possible to provide an alternative embodiment which is space-saving in terms of construction.

In an advantageous embodiment, it can be provided that a push button is present, bits or sockets being able to be blocked and released thereby. Thus the user can fasten in position or release the bits or sockets in a simple manner.

The push button is coupled to a restoring element, for example a spring, which encompasses the drive shaft and holds the push button in a resting position which corresponds to a blocked state. The user has to push the push button and thus exert a force on the restoring element in order to release the blocking so as to remove, for example, a socket or a bit.

In an advantageous embodiment, it can be provided that the rotary tool has a blocking device which secures the bits or sockets fixedly in rotation to the drive shaft or releases said bits or sockets. Additionally it can be provided that a control element of the blocking device is guided through the freewheel mechanism. Thus the bits or sockets can be attached to an actuating pin of the rotary tool and positioned and secured in a mechanically stable manner, or released. Moreover, an ergonomic actuation can be achieved and the space requirement can be reduced as a whole.

### BRIEF DESCRIPTION OF THE DRAWINGS

The invention is now described in more detail by way of a few exemplary embodiments but is not limited to these few exemplary embodiments. Further variants and exemplary embodiments are found by combining the features of individual or a plurality of protected claims with one another and/or with individual or a plurality of features of the exemplary embodiments and/or the above-described variants of devices according to the invention.

In the drawings:

FIG. 1 shows a rotary tool according to the invention in a side view;

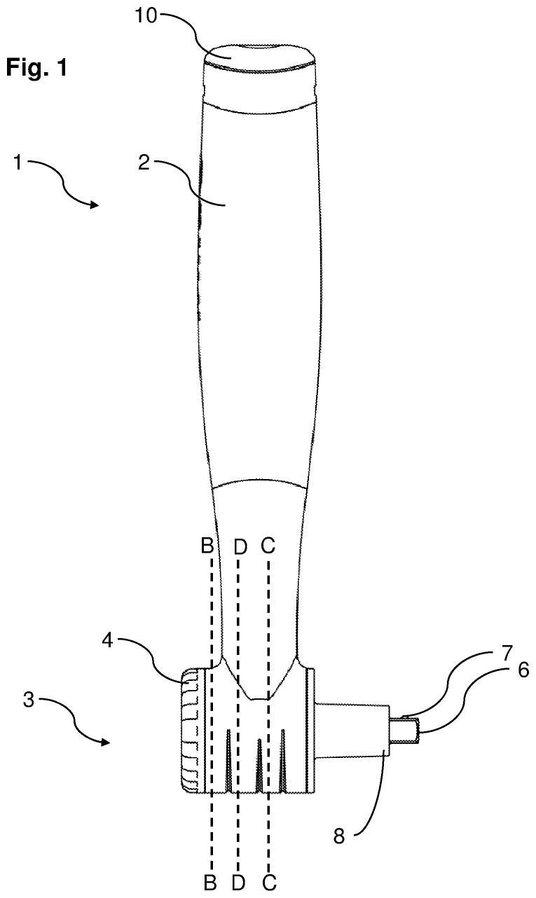

FIG. 2 shows the rotary tool in a view from above;

FIG. 3 shows the rotary tool in a sectional view through the plane A-A;

FIG. 4 shows the rotary tool in a sectional view through the plane B-B;

FIG. 5 shows the rotary tool in a sectional view through the plane C-C;

FIG. 6 shows the rotary tool in a sectional view through the plane D-D;

FIG. 7 shows the rotary tool in an exploded drawing in a perspective view;

FIG. 8 shows the rotary tool in a sectional view through the plane A-A with integrated sockets; and

FIG. 9 shows a rotary tool in an alternative geometric embodiment.

### DETAILED DESCRIPTION

In the following description of various exemplary embodiments of the invention, elements which are the same in terms of their function, even in the case of a different design or shape, are provided with the same reference signs.

For a clearer overview, not all reference signs are provided in the figures, even though the elements can still be present in the figures. The same reference signs, however, denote components and functional units which are functionally and/or structurally the same.

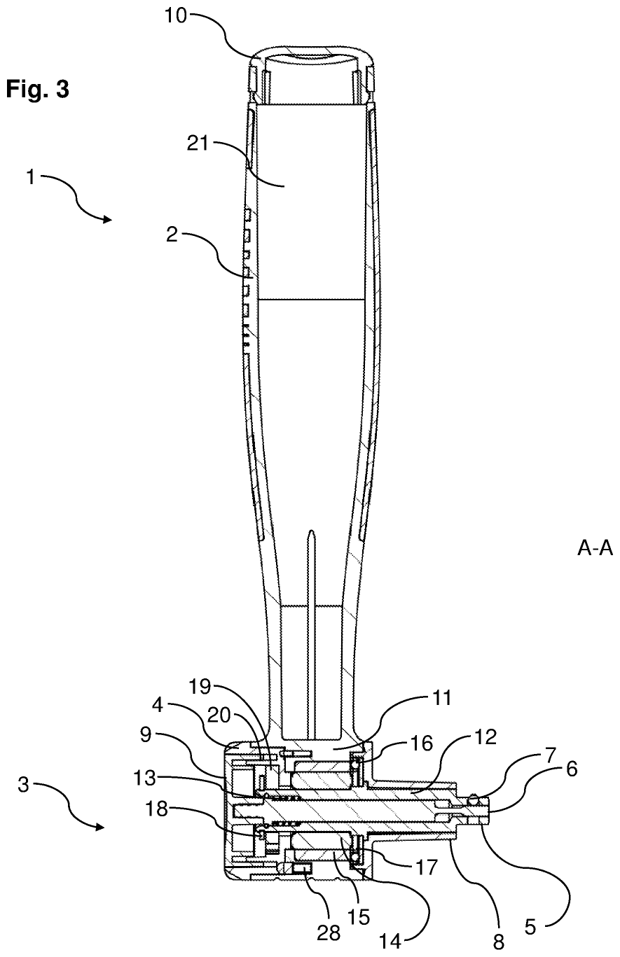

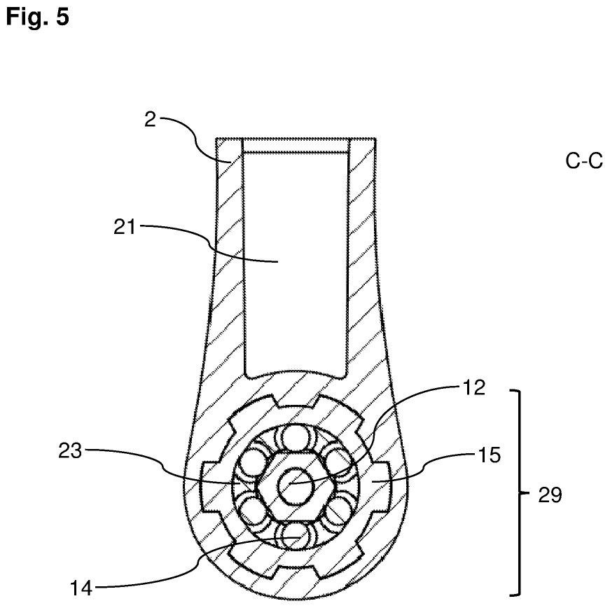

The rotary tool 1 has a handle 2 and an actuating part 3. The actuating part 3 comprises a push button 9 (see FIG. 3), a rotatable ring 4, a drive shaft 12 (see FIG. 3), a freewheel mechanism 29 (see FIG. 5) and an actuating pin 5.

The main axis of the handle 2 is arranged at right angles to the axis of rotation of the drive shaft 12.

At its lower point the actuating pin 5 comes into contact with a tool attachment point 6.

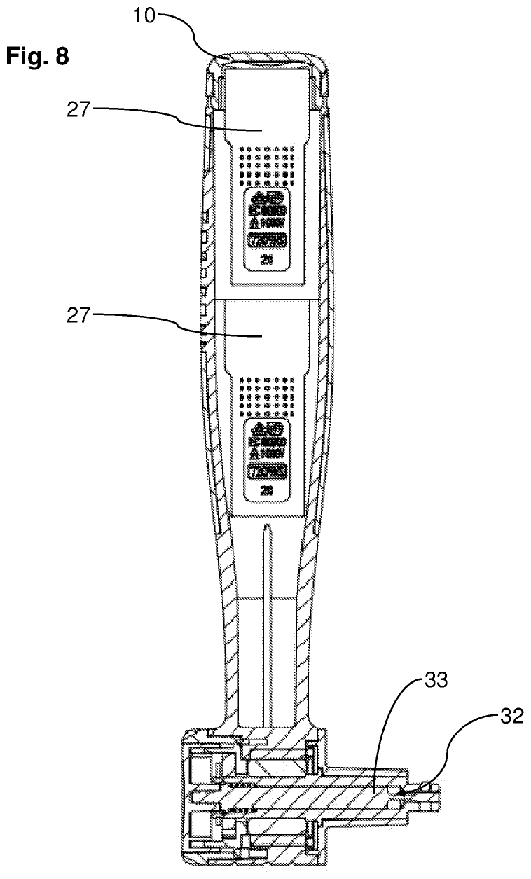

A ball 7 which belongs to a blocking device 32 (see FIG. 8) of the rotary tool 1 is also visible.

Additionally, a housing part 8 which encloses a part of the drive shaft 12 is also visible. The housing part 8 is preferably made of plastics or a different electrically non-conductive material.

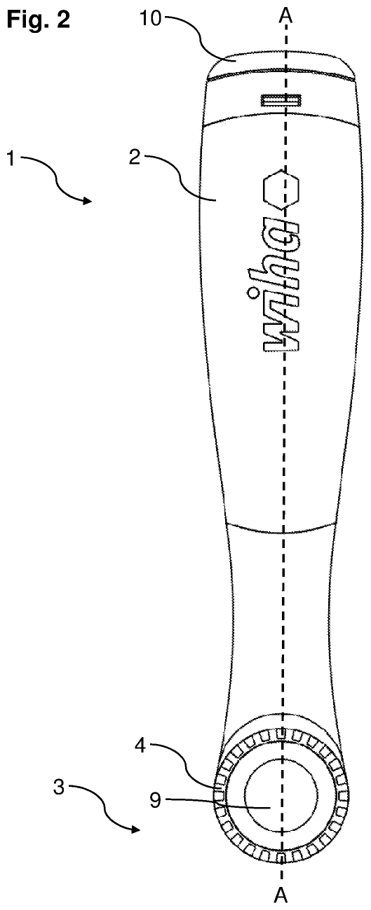

FIG. 2 shows the rotary tool 1 in a view from above. The handle 2 is in contact with an end position of the actuating part 3. The actuating part 3 comprises, amongst other things, the push button 9 and the rotatable ring 4.

A blocking device 32 of the rotary tool 1 can be actuated by the push button 9. The blocking device 32 serves for fastening sockets 27 to the actuating pin 5 and for releasing said sockets. A changeover device 31 which defines and sets the rotational direction of the drive shaft 12 can be actuated by the rotatable ring 4.

FIG. 3 shows the rotary tool 1 in a sectional view through the plane A-A.

The handle 2, preferably consisting of plastics, has a hollow interior 21 which can be closed by a closure cap 10. The hollow interior 21 is fully sealed relative to the actuating part 3 which accommodates, amongst other things, the freewheel mechanism 29. The hollow interior 21 is fully sealed relative to the freewheel mechanism 29 by means of an insulator 11. The insulator 11 is preferably produced from plastics. The insulator 11 can be configured as a one-piece plastics shaped portion.

The push button 9 is operatively connected and in contact with the drive shaft 12. At the lower end of the drive shaft 12, the drive shaft 12 is in contact with a ball 7 which forms part of the blocking device 32. The drive shaft 12 has on the lower end a circulating groove in which the ball 7 can be introduced. A user who actuates the push button 9, and thus exerts an axial force, thereby pushes the drive shaft 12 downwardly, wherein the peripheral groove is pushed downwardly and whereby the ball 7 can be moved into the peripheral groove. Thus the blocking device 32 becomes releasable and a socket 27 or a bit can be removed from the actuating pin 5.

The blocking device 32 has two possible positions: a fixed or blocked position in which a socket 27 is axially fixed on the drive shaft 12 and a released position in which the socket 27 can be removed from the drive shaft 12.

A restoring element 13 encompasses the drive shaft 12 and ensures that in a zero position, in which no axial force is exerted by a user on the push button 9, the blocking device 32 is in a fixed position. The restoring element 13 can be configured as a spring.

The drive shaft 12 can have a hexagonal cross section.

The freewheel mechanism 29 has clamping elements 14 which encompass the drive shaft 12 by contact. The clamping elements 14 can be configured as rolling bodies. Preferably, the rolling bodies are balls and/or cylindrical rollers. At least three clamping elements 14 are configured. With a rotation of the handle 2 the clamping elements 14 are pushed against a corner of the preferably hexagonal drive shaft 12. Clamping is produced since the spacing between the corner of the drive shaft 12 and an outer cage 15 (see FIG. 5) is smaller than the diameter of a clamping element 14. Thus the user can transmit a rotational movement on the outer cage 15 by means of the handle 2 and thus transmit a torque via the clamping elements 14 onto the drive shaft 12. The outer cage 15 has on its inner face a cylindrical surface on which the clamping elements 14 can roll.

In a central part the drive shaft 12 is encompassed by an axial rolling bearing 16. The freewheel mechanism 29 is supported via the axial rolling bearing 16 on the drive shaft 12. Preferably, a part of the freewheel mechanism 29, which is connected fixedly in terms of rotation to the handle 2, is supported via the axial rolling bearing 16 against the drive shaft 12. The axial rolling bearing 16 can be configured as an axial ball bearing. The rolling bodies of the axial rolling bearing 16 run on a disk 17 which encompasses the drive shaft 12. The disk 17 is arranged between the axial rolling bearing 16 and the housing part 8. The function of the axial rolling bearing 16 is intended to be the receiving and diverting of an axial force which is introduced by a user onto the actuating part 3.

In FIG. 3 it is additionally also visible that a securing element 18, which is preferably configured to be disk-shaped, encompasses the drive shaft 12 and additionally or alternatively axially secures an adapter element 19. The securing element 18 can be configured as a securing ring.

The adapter element 19 and the drive shaft 12 are preferably produced from different materials. This is advantageous so that optimized material pairings can be selected and thus the wear and friction of the elements can be reduced.

The rotary tool 1 has a changeover device 31 for the freewheel mechanism 29. The changeover device 31 cooperates with the adapter element 19 for fixing at least one switching position, wherein the adapter element 19 is connected fixedly in terms of rotation to the drive shaft 12 of the rotary tool 1.

The adapter element 19 is operatively connected to the rotatable ring 4. By rotating the rotatable ring 4, a user can access the adapter element 19 which in turn can actuate and switch the changeover device 31 so that a possible rotational direction of the drive shaft 12 can be set.

The adapter element 19 consists of plastics. This plastic can be, for example, a polyamide or a polyoxymethylene (POM). The adapter element 19 has an internal hexagon which is located fixedly in terms of rotation on the drive shaft 12.

A labyrinth structure 20, which is preferably produced from plastics, is configured between the securing element 18 and the handle 2. The labyrinth structure 20 extends the creep distances and air gaps between the securing element 18 and a location outside the rotary tool 1 so that legal requirements and standards can be met relative to product safety in the case of electrical sparking.

A control element 33 of the blocking device 32 is guided through the freewheel mechanism 29. It is advantageous that an ergonomic actuation can be achieved and also that a space saving can be achieved. The securing element 18 can consist of a metal.

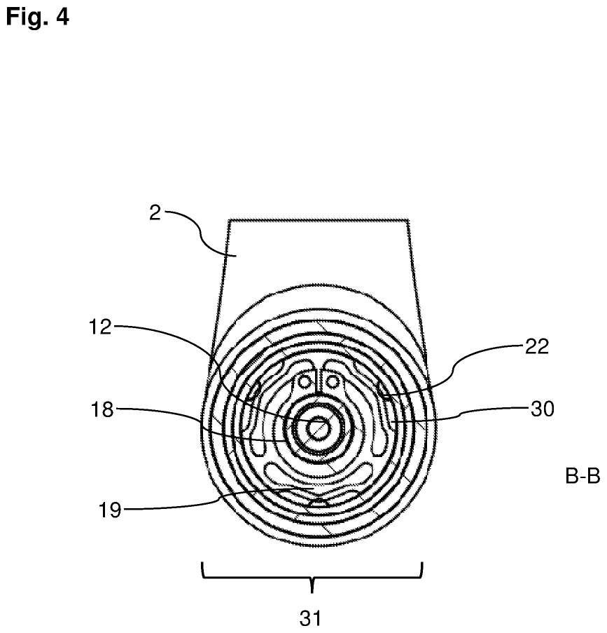

FIG. 4 shows the rotary tool 1 in a sectional view through the plane B-B.

The securing element 18 which encompasses the drive shaft 12 and axially secures the adapter element 19 is visible in FIG. 4.

The changeover device 31 has spring elements 22. The adapter element 19 has end stops 30 on both sides for the changeover device 31. Preferably, the end stops 30 are configured on the spring elements 22. The spring elements 22 provide a radial spring assembly. The adapter element 19 can move on the spring elements 22 and take up its position. The adapter element 19 can set a rotational direction of the drive shaft 12 according to the position of the adapter element 19 relative to the spring element 22. A rotational direction of the drive shaft 12 can be defined and set only when the adapter element 19 is in contact with one of the end stops 30. Thus it is possible to change between a right-hand rotation and a left-hand rotation.

The spring elements 22 can be arranged in the form of a latching sliding guide.

The spring elements 22 are produced from plastics. Preferably this plastic is a polyoxymethylene (POM). The plastics can alternatively also be a polyamide. The invention has identified for the first time here that a material combination of polyoxymethylene and polyamide for the adapter element 19 and the spring elements 22 can increase the service life of the changeover device 31 and the sliding friction can be improved so that a resistance against a switching movement of the changeover device 31 can be achieved by the shaping of the spring elements 22.

FIG. 5 shows the rotary tool 1 in a sectional view through the plane C-C.

The rotary tool 1 has clamping elements 14 which are arranged between the drive shaft 12 and the outer cage 15. The outer cage 15 has on its inner face a cylindrical surface on which the clamping elements 14 can roll. The clamping elements 14 are arranged in an internal structure 23, wherein the internal structure 23 has grooves in which the clamping elements 14 are arranged. The internal structure 23 is used in order to position the clamping elements 14. The internal structure 23 can be operatively connected to the adapter element 19 in order to be latched between the switching positions.

Depending on the switching position, the outer cage 15 thus prevents the clamping elements 14 from being blocked in one or both rotational directions. Thus it is possible to set a torque transmission from the handle 2 to the drive shaft 12 which is dependent on the rotational direction.

The outer cage 15 is used in order to transmit a torque from the handle 2 to the clamping elements 14. The outer cage 15 on its outer face has a tongue-groove connection with the handle 2. The outer cage 15 can be configured as a splined shaft.

The freewheel mechanism 29 is configured here as a clamping roller mechanism.

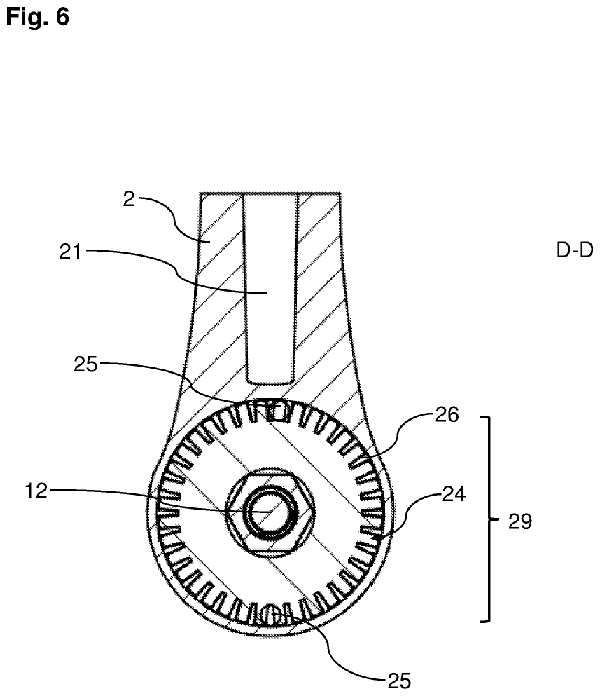

FIG. 6 shows the rotary tool 1 in a sectional view through the plane D-D.

The freewheel mechanism 29 has a latching mechanism 24. The latching mechanism 24 has two latching elements 25 which run on a latching profile 26 of predetermined spacing. The latching elements 25 are arranged offset to one another by a fraction of the spacing. Preferably, the fraction of the spacing is an angle of less than 10°, equal to 5° here. A steady running noise can be achieved when the offset is equal to half the spacing.

The two latching elements 25 can be designed as latching balls.

The angular offset of the two latching elements 25 is not an integer multiple of the spacing of the latching profile 26. An acoustic feedback during the movement of the freewheel mechanism 29 can be generated by the latching mechanism 24, wherein the acoustic feedback is generated by the movement of the latching elements 25 on the latching profile 26.

The frequency of the acoustic feedback (relative to a rotational angle) can be set by the angular offset of the two latching elements 25 to one another.

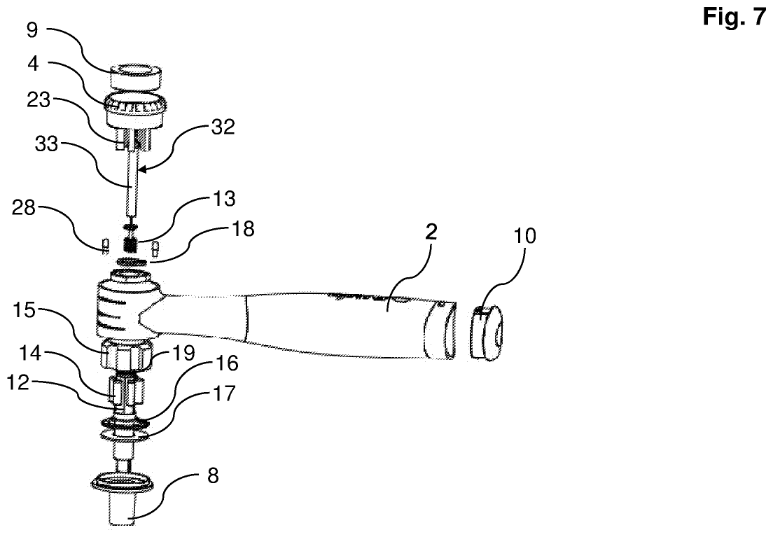

FIG. 7 shows the rotary tool 1 in an exploded drawing in a perspective view.

FIG. 8 shows the rotary tool 1 in a sectional view through the plane A-A with integrated sockets 27. The remaining elements are identical to the elements of FIG. 3.

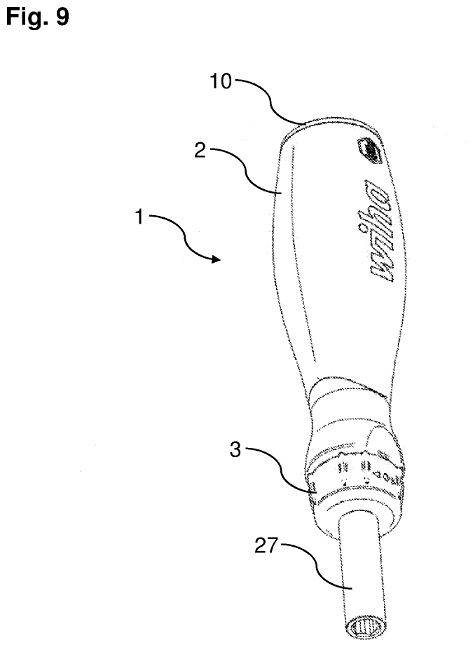

FIG. 9 shows the rotary tool 1 in an alternative geometric embodiment. Here the main axis of the handle 2 is coaxial with the rotational axis of the drive shaft 12 (not visible here). The rotary tool 1 is shown here with a socket 27 in position. The freewheel mechanism 29 (not visible here) is accommodated in the actuating part 3. The changeover device 31 can be switched and set by a rotation of the actuating part 3. The handle 2 has a hollow interior 21 (see FIG. 3) in which sockets 27 can be accommodated. The hollow interior 21 can be sealed by a closure cap 10.

In a rotary tool 1 for tightening or releasing a screw connection, wherein the rotary tool 1 has a freewheel mechanism 29, it is proposed that the rotary tool 1 is configured to be electrically isolated at least in a partial region between a tool attachment point 6 and the freewheel mechanism 29.

### LIST OF REFERENCE SIGNS

1 Rotary tool
2 Handle
3 Actuating part
4 Ring
5 Actuating pin
6 Tool attachment point
7 Ball
8 Housing part
9 Push button
10 Closure cap
11 Insulator
12 Drive shaft
13 Restoring element
14 Clamping element, clamping elements
15 Outer cage
16 Axial rolling bearing
17 Disk
18 Securing element
19 Adapter element
20 Labyrinth structure
21 Interior
22 Spring element, spring elements
23 Internal structure
24 Latching mechanism
25 Latching element, latching elements
26 Latching profile
27 Socket, sockets
28 Spring sleeve
29 Freewheel mechanism
30 End stop, end stops
31 Changeover device
32 Blocking device
33 Control element

1. A rotary tool (1) for tightening or releasing a screw connection, the rotary tool (1) comprising
a freewheel mechanism (29);
a tool attachment point; and
wherein the rotary tool (1) is electrically isolated at least in a partial region between the tool attachment point (6) and the freewheel mechanism (29).

2. The rotary tool (1) according to claim 1, wherein the freewheel mechanism (29) comprises a clamping roller mechanism.

3. The rotary tool (1) according to claim 1, further comprising a changeover device (31) for the freewheel mechanism (29).

4. The rotary tool (1) according to claim 3, further comprising a drive shaft (12), the changeover device (31) cooperates with an adapter element (19) for fixing at least one switching position, and the adapter element (19) is connected fixedly in terms of rotation to the drive shaft (12).

5. The rotary tool (1) according to claim 4, wherein the adapter element (19) and the drive shaft (12) are produced from different materials.

6. The rotary tool (1) according to claim 1, wherein the freewheel mechanism (29) has clamping elements (14) comprising at least one of rolling bodies, balls or cylindrical rollers.

7. The rotary tool (1) according to claim 6, wherein there are at least three of the clamping elements (14).

8. The rotary tool according to claim 3, wherein the changeover device (31) has spring elements (22).

9. The rotary tool (1) according to claim 4, wherein the adapter element (19) has end stops (30) on both sides for the changeover device (31) and the end stops are configured on spring elements (22) of the changeover device.

10. The rotary tool (1) according to claim 9, wherein the spring elements (22) provide a radial spring assembly.

11. Rotary The rotary tool (1) according to claim 9, wherein the spring elements (22) are produced from plastics material.

12. The rotary tool (1) according to claim 4, wherein the adapter element (19) is produced from a plastics material.

13. The rotary tool (1) according to claim 9, wherein the spring elements (22) are arranged as a latching sliding guide.

14. The rotary tool (1) according to claim 4, further comprising a disk-shaped securing element (18) that encompasses at least one of the drive shaft (12) or axially secures the adapter element (19).

15. The rotary tool (1) according to claim 4, further comprising a handle, and a labyrinth structure (20), is configured between the securing element (18) and a handle (2).

16. The rotary tool (1) according to claim 15, wherein a part of the freewheel mechanism (29) which is connected fixedly in terms of rotation to the handle (2), is supported via an axial rolling bearing (16) on the drive shaft (12).

17. The rotary tool (1) according to claim 1, wherein the freewheel mechanism (29) has a latching mechanism (24).

18. The rotary tool (1) according to claim 17, wherein the latching mechanism (24) has two latching elements (25), which run on a latching profile (26) of predetermined spacing, wherein and the latching elements (25) are arranged offset to one another by a fraction of the spacing.

19. The rotary tool (1) according to claim 15, wherein the handle (2) has a hollow interior (21) which is fully sealed relative to the freewheel mechanism (29) by of an insulator (11).

20. The rotary tool (1) according to claim 19, wherein at least one of sockets (27) or bits are introducible in the interior (21) and the interior (21) is closeable by a closure cap (10).

21. The rotary tool (1) according to claim 1, further comprising a push button (9), and bits and sockets (27) are blockable and releasable via the push button.

22. The rotary tool (1) according to claim 1, further comprising a blocking device (32) which secures bits or sockets (27) fixedly in terms of rotation to the drive shaft (12) or releases said bits or sockets, and a control element (33) of the blocking device (32) is guided through the freewheel mechanism (29).
